(19) United States
(12) Patent Application Publication
(10) Pub. No.: US 2023/0169094 A1
(43) Pub. Date: Jun. 1, 2023

(54) INFORMATION PROCESSING SYSTEM, INFORMATION PROCESSING APPARATUS, AND INFORMATION PROCESSING METHOD

(71) Applicant: Naoya Kitoh, Tokyo (JP)

(72) Inventor: Naoya Kitoh, Tokyo (JP)

(73) Assignee: Ricoh Company, Ltd., Tokyo (JP)

(21) Appl. No.: 18/053,159

(22) Filed: Nov. 7, 2022

(30) Foreign Application Priority Data
Nov. 30, 2021 (JP) 2021-194643

(51) Int. Cl. G06F 16/28; G06F 40/56

(52) U.S. Cl. CPC G06F 16/28; G06F 40/56

(57) ABSTRACT

An information processing system, an information processing apparatus, and an information processing method. The information processing system stores in one or more memories, scenario information for associating a scenario with an object for leading from question information to answer information in the scenario, receives input information from a terminal device and transmit response information responding to the input information to the terminal device based on the scenario information, receives a change to the object included in the scenario information, and determines whether a parent object having a corresponding relationship with a child object for which the change has been received exists.

### CROSS-REFERENCE TO RELATED APPLICATIONS

This patent application is based on and claims priority pursuant to 35 U.S.C. §119(a) to Japanese Patent Application No. 2021-194643 , filed on Nov. 30, 2021, in the Japan Patent Office, the entire disclosure of which is hereby incorporated by reference herein.

### BACKGROUND

### Technical Field

The present disclosure relates to an information processing system, an information processing apparatus, and an information processing method.

### Background Art

In recent years, chatbot is used to reduce cost and improve operational efficiency in guidance and inquiries about products and services. However, maintenance of the chatbot in order to facilitate end users to get the answers is sometimes troublesome for an administrator.

### SUMMARY

Embodiments of the present disclosure describe an information processing system, an information processing apparatus, and an information processing method. The information processing system stores in one or more memories, scenario information for associating a scenario with an object for leading from question information to answer information in the scenario, receives input information from a terminal device and transmit response information responding to the input information to the terminal device based on the scenario information, receives a change to the object included in the scenario information, and determines whether a parent object having a corresponding relationship with a child object for which the change has been received exists.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of a chatbot system according to embodiments of the present disclosure;

FIG. 2 is a block diagram illustrating a hardware configuration of a platform according to embodiments of the present disclosure;

FIG. 3 is a block diagram illustrating a functional configuration of an application server included in the platform according to embodiments of the present disclosure;

FIG. 4 is a diagram illustrating an example of a flow of messages displayed by a chatbot executed in the chatbot system according to embodiments of the present disclosure;

FIG. 5 is a flowchart illustrating an example of an object change process executed by the chatbot system according to embodiments of the present disclosure;

FIG. 6 is a diagram illustrating an example of a scenario creation screen displayed by the chatbot system according to embodiments of the present disclosure;

FIG. 7 is a diagram illustrating an example of a custom scenario screen displayed by the chatbot system according to embodiments of the present disclosure;

FIG. 8 is a diagram illustrating an example of a scenario management screen displayed by the chatbot system according to embodiments of the present disclosure;

FIG. 9 is a diagram illustrating another example of the scenario management screen displayed by the chatbot system according to embodiments of the present disclosure; and

FIGS. 10A and 10B are diagrams illustrating another example of the scenario management screen displayed by the chatbot system according to embodiments of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, a description is given of several embodiments of an information processing system, an information processing apparatus, and an information processing method.

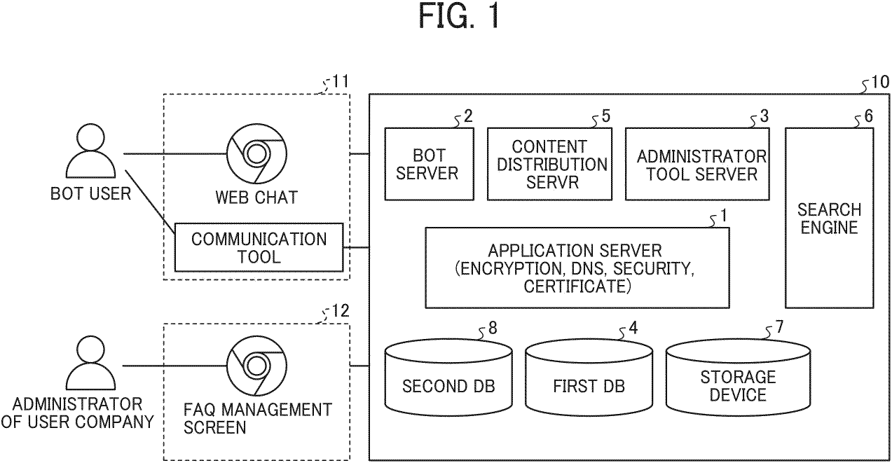

FIG. 1 is a diagram illustrating a configuration of a chatbot system according to the present embodiment. As illustrated in FIG. 1, the chatbot system (an example of the information processing system and the information processing apparatus) of the present embodiment includes a platform 10, a user terminal 11 of a user of the chatbot system, and an administrator terminal 12 of an administrator of a company or the like. The user terminal 11 and administrator terminal 12 are, for example, personal computers, tablet terminals, smartphones, and the like, and are connected to each device of the present embodiment through networks such as the internet and local area network (LAN). In FIG. 1, each of the platform 10, user terminal 11, and administrator terminal 12 is illustrated as a single unit, but two or more units of each device may be included.

The user terminal 11 of the user of the chatbot system is a terminal device with which the user browses a home page and chats, or a terminal device with which a chat is performed using an installed communication tool.

As an example, the platform 10 includes an application server 1, a bot server 2, an administrator tool server 3, a first database (DB) 4, a content distribution server 5, a search engine 6, a storage device 7 and a second DB 8.

Each device 1 to 8 of the platform 10 may be implemented by one server, or one server may be provided for each service. Further, a configuration in which one service is implemented by one server and a configuration in which a plurality of services are implemented by one server may be mixed. Furthermore, one service may be implemented by distributed processing by a plurality of servers.

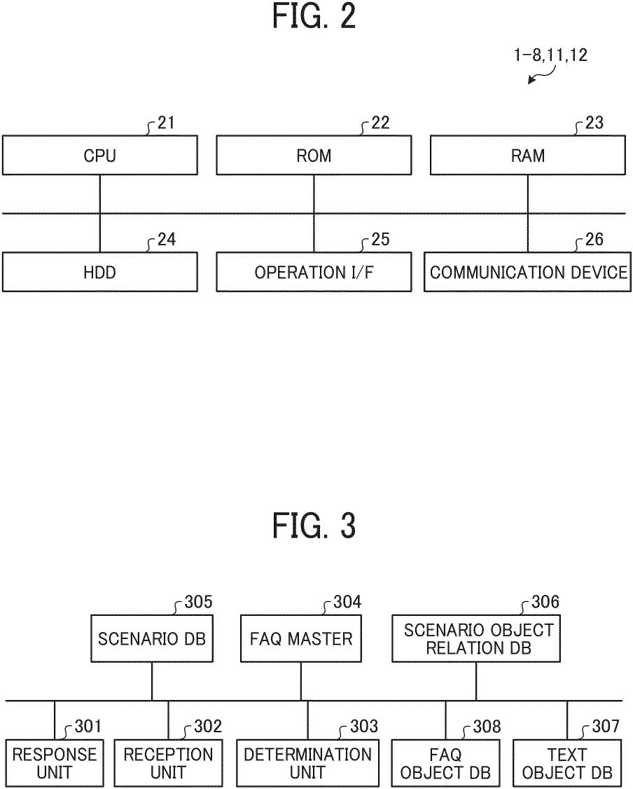

FIG. 2 is a block diagram illustrating a hardware configuration of the platform according to the present embodiment. As illustrated in FIG. 2, each device 1 to 8 includes a central processing unit (CPU) 21, a read only memory (ROM) 22, a random access memory (RAM) 23, a hard disk drive (HDD) 24, an operation interface (I/F) 25, and a communication device 26.

FIG. 3 is a block diagram illustrating a functional configuration of the application server of the platform according to the present embodiment. By executing an information processing program stored in the HDD 24, the CPU 21 of the application server 1 functions as a response unit 301, a reception unit 302, and a determination unit 303, as illustrated in FIG. 3.

The HDD 24 also functions as a frequently asked question (FAQ) master 304, a scenario DB 305, a scenario object relation DB 306, a text object DB 307, and an FAQ object DB 308, as illustrated in FIG. 3.

The FAQ master 304 is a DB that associates and stores question information and answer information to the question information. In the present embodiment, the FAQ master 304 associates and stores a question identifier (ID), which is identification information of the question information, the question information, and the answer information, as illustrated in Table 1 below.

TABLE 1

| Question ID | Question Information | Answer Information |
|---|---|---|
| 1 | Contact | Link to Contact |
| 2 | Product A | Link to Case Study |
| 3 | Product B | Link to Case Study |

The scenario DB 305 is a DB that stores a scenario in which the question information is led to the answer information by the chatbot, and a message that is displayed first in the scenario. In the present embodiment, the scenario DB 305 is a DB that associates and stores a chatbot ID, a scenario ID, a title, and a scenario name, as illustrated in Table 2 below. Here, the chatbot ID is identification information for identifying the chatbot, and the scenario ID is identification information for identifying the scenario. The title is text that the chatbot displays on a button. The scenario name is a name of the scenario.

For example, in the case the chatbot system according to the present embodiment is a chatbot system used in-house, the chatbot scenario is created for each department (for example, general affairs, accounting), so a department name is used as the scenario name.

TABLE 2

| Chatbot ID | Scenario ID | Title | Scenario Name |
|---|---|---|---|
| 1 | 2 | Custom Scenario Flow 6 | Flow 6 |
| 2 | 1 | Chatbot | Flow 1 |

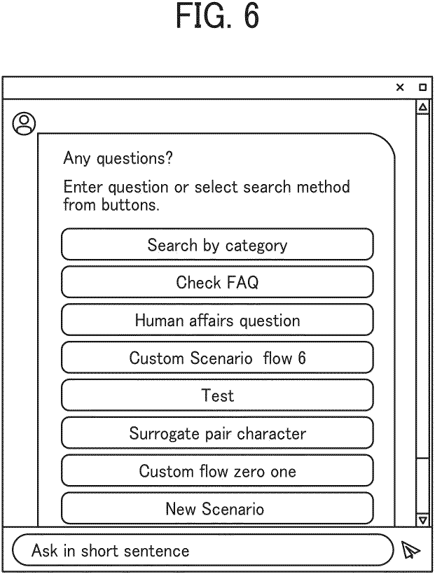

The scenario object relation DB 306 is a DB for storing a parent-child relationship between objects in the scenario. Here, the object is an object for guiding the question information to the answer information in the scenario. For example, the object includes an object for leading the questioner to the correct answer information (such as “personnel question” (see FIG. 6)) from the question information such as “Do you have any questions?” (See FIG. 6).

In the present embodiment, the scenario object relation DB 306 is a DB that associates and stores the scenario ID, a parent object ID, and a child object ID, as illustrated in Table 3 below. Here, the parent object ID is identification information of a parent object. The child object ID is the identification information of a child object.

TABLE 3

| Scenario ID | Parent Object ID | Child Object ID |
|---|---|---|
| 1 | NULL | 1 |
| 1 | 1 | 2 |
| 1 | 2 | 3 |
| 1 | 2 | 4 |
| 1 | 3 | 5 |
| 1 | 3 | 6 |

The text object DB 307 is a DB for storing an object that are used in nodes other than a leaf node. The object ID is a unique value including the FAQ object DB 308. In the present embodiment, the text object DB 307 is a DB that associates and stores the scenario ID, the object ID, and the text, as illustrated in Table 4 below. Here, the text is the text to display on the object.

TABLE 4

| Scenario ID | Object ID | Text |
|---|---|---|
| 1 | 2 | Chatbot |
| 1 | 3 | Case Study |
| 1 | 4 | By Product |

The FAQ object DB 308 is a DB for storing the object used in the leaf node, and is an example of the scenario information that associates the scenario with the object leading from the question information to the answer information in the scenario. Also, the FAQ object DB 308 manages a linkage between the object and the question ID. In the present embodiment, the FAQ object DB 308 is a DB that associates and stores the scenario ID, the object ID, and the question ID, as illustrated in Table 5 below.

TABLE 5

| Scenario ID | Object ID | Question ID |
|---|---|---|
| 1 | 4 | 1 |
| 1 | 5 | 2 |
| 1 | 6 | 3 |

The reception unit 302 receives a change (for example, deletion) of the object included in the FAQ object DB 308. In the present embodiment, the reception unit 302 receives the change to the object included in the FAQ object DB 308 from the administrator terminal 12 (an example of a terminal device). In the present embodiment, reception unit 302 is implemented by a function other than the chatbot function.

The response unit 301 receives message information (an example of input information) from the user terminal 11 (an example of the terminal device). The response unit 301 transmits message information (an example of response information) corresponding to the received message information to the user terminal 11 based on the FAQ object DB 308. The response unit 301 is implemented by the chatbot function.

In response to receiving the change such as deletion of an object by the reception unit 302, the determination unit 303 refers to the scenario object relation DB 306 and determines whether there is a parent object that has a corresponding relationship with the child object that is a target of the change. In the present embodiment, determination unit 303 is implemented by a function other than the chatbot function.

Based on a determination that the parent object does not exist, the reception unit 302 changes the scenario associated with the child object in the FAQ object DB 308. Accordingly, when the chatbot administrator changes an object in the chatbot scenario, the scenario associated with the changed object is also changed. As a result, time and effort for maintenance of the scenario by the chatbot administrator is reduced.

Also, before changing the scenario associated with the child object in the FAQ object DB 308, the reception unit 302 displays the scenario to be changed on a display (for example, the administrator terminal 12). As a result, the scenario to be changed is displayed on the display before the scenario associated with the changed object is changed, and the chatbot administrator can be alerted (warned) about the change in the scenario.

Furthermore, in the case the parent object exists, the determination unit 303 refers to the scenario object relation DB 306 to determine whether there is another child object that has the corresponding relationship with the parent object. Based on a determination that there is no other child object that has the corresponding relationship with the parent object, the reception unit 302 changes the parent object also. On the other hand, in the case there is another child object that has the corresponding relationship with the parent object, the reception unit 302 leaves the parent object unchanged.

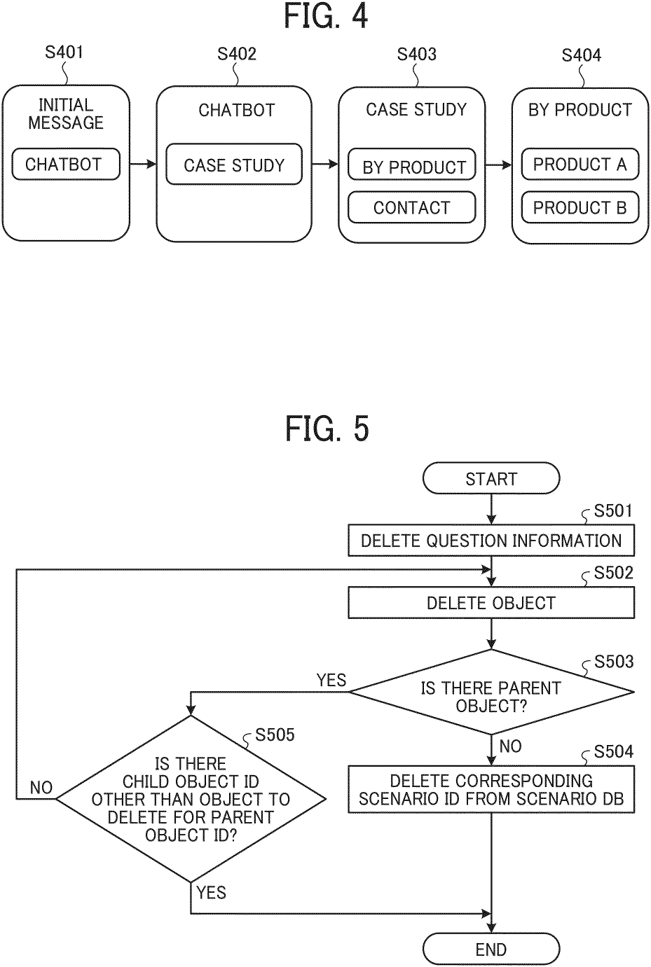

FIG. 4 is a diagram illustrating an example of a flow of messages displayed by the chatbot executed in the chatbot system according to the present embodiment. Here, for example, an example of displaying an object according to a scenario with scenario ID: 1 in the scenario DB 305 is described. In step S401, the response unit 301 displays a first message for requesting execution of the chatbot on the user terminal 11.

In response to receiving a click on the first message by the user of the chatbot system to request execution of the chatbot, the response unit 301 identifies, in the scenario object relation DB 306, the child object ID: 2 associated with the object ID (child object ID: 1) associated with the scenario ID of the chatbot requested to be executed. In step S402, the response unit 301 displays on the user terminal 11, the text “chatbot” which is the object of the identified child object ID: 2 in the text object DB 307.

In response to receiving a click on the object with object ID: 2 by the user of the chatbot system, the response unit 301 identifies the child object ID: 3 associated with the object ID: 2 that is the parent object ID in the scenario object relation DB 306. In step S403, the response unit 301 displays, on the user terminal 11, the text “case study” which is the object of the identified child object ID: 3 in the text object DB 307.

Furthermore, in response to receiving a click on the object with object ID: 3 by the user of the chatbot system, the response unit 301 identifies the child object ID: 4 associated with the object ID: 3, which is the parent object ID, in the scenario object relation DB 306. In step S404, the response unit 301 displays on the user terminal 11, a text “by product”, which is the object of the identified child object ID: 4 in the text object DB 307.

FIG. 5 is a flowchart illustrating an example of an object change process executed by the chatbot system according to the present embodiment. In response to receiving a change (for example, deletion) of an object such as the question information by the reception unit 302 in step S501, the reception unit 302 deletes the object ID and the text of the object whose change has been received in the text object DB 307 in step S502.

In step S503, the determination unit 303 refers to the scenario object relation DB 306 and determines whether there is a parent object ID associated with the child object ID of the deleted child object.

In step S504, based on a determination that there is no parent object ID associated with the object ID of the deleted child object (step S503: No), the reception unit 302 deletes the scenario ID of the scenario including the deleted object from the scenario DB 305.

Based on a determination that there is a parent object ID associated with the object ID of the deleted object (step S503: Yes), the determination unit 303 refers to the scenario object relation DB 306 and determines whether there is another child object ID associated with the parent object ID in step S505.

Based on a determination that there is another child object ID (step S505: Yes), the reception unit 302 ends the object change process without deleting the object associated with the deleted object. Based on a determination that there is no other child object ID (step S505: No), the reception unit 302 returns to step S502 and deletes the object with the parent object ID.

FIG. 6 is a diagram illustrating an example of a scenario creation screen displayed by the chatbot system according to the present embodiment. In the present embodiment, as illustrated in FIG. 6, the reception unit 302 displays the scenario creation screen on which the object (for example, “custom scenario flow 6”) that is the target of creating chatbot scenario is arranged on the administrator terminal 12.

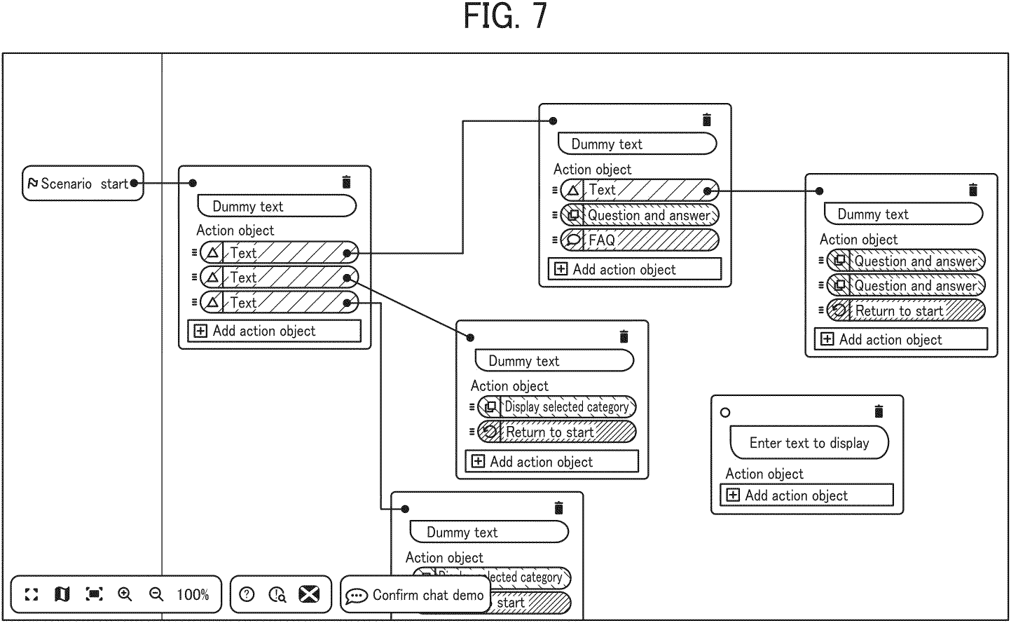

FIG. 7 is a diagram illustrating an example of a custom scenario screen displayed by the chatbot system according to the present embodiment. In the present embodiment, in response to receiving a request for a chatbot scenario creation process, the reception unit 302 displays the custom scenario screen on the administrator terminal 12 as illustrated in FIG. 7. The custom scenario screen includes the chatbot scenario and objects included in the scenario, as illustrated in FIG. 7. The administrator of the chatbot system sets how the chatbot interacts with the user (for example, exchange of the question information and the answer information) on the custom scenario screen.

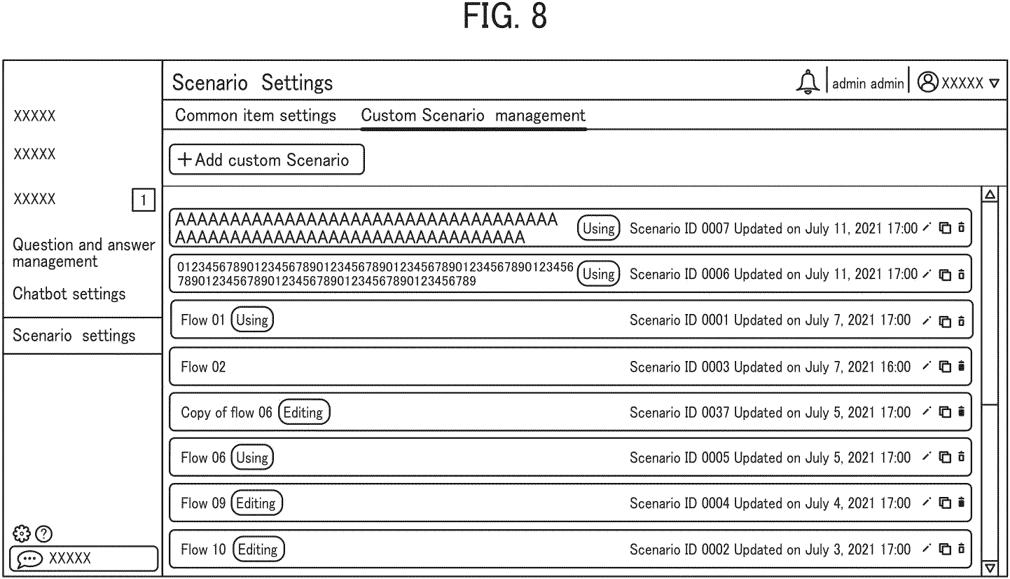

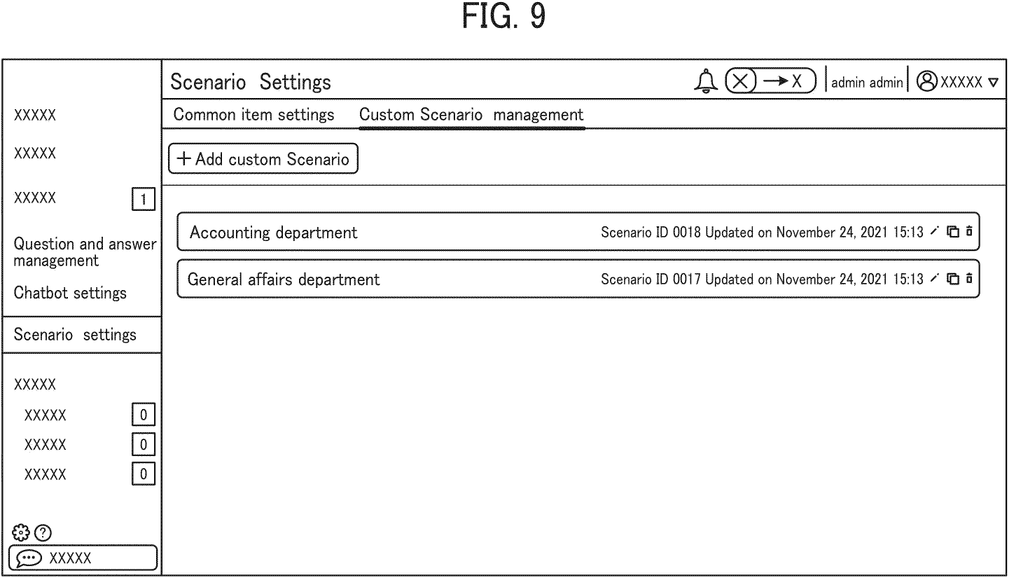

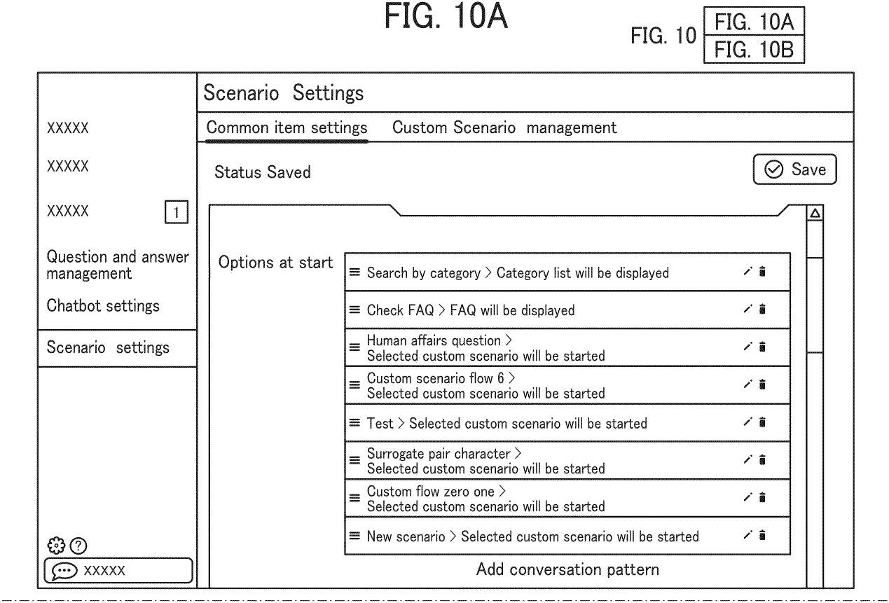

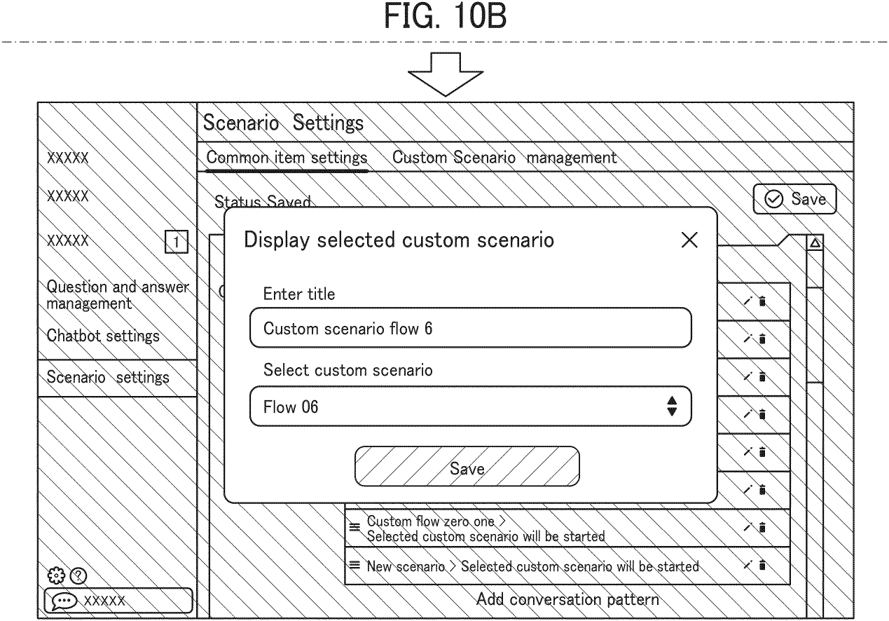

FIGS. 8, 9, 10A, and 10B are diagrams illustrating examples of scenario management screens displayed by the chatbot system according to the present embodiment. In the present embodiment, as illustrated in FIG. 8, the reception unit 302 displays on the administrator terminal 12, the scenario management screen for selecting a scenario to be set from the chatbot scenarios. For example, in the case the chatbot system according to the present embodiment is a chatbot system used in-house, a chatbot scenario is created for each department (for example, for general affairs department, and for accounting department). Accordingly, the reception unit 302 displays on the administrator terminal 12, the scenario management screen from which scenarios created for each department can be selected, as illustrated in FIG. 9. In response to receiving a selection of a scenario to be changed on the scenario management screen, the reception unit 302 enables selection of which of the objects of the selected scenario is to be displayed as a chatbot on a common item setting screen of the scenario management screen, as illustrated in FIGS. 10A and 10B.

As described above, according to the chatbot system of the present embodiment, when the chatbot administrator changes an object in the scenario of the chatbot, the scenario associated with the changed object is also changed. As a result, time and effort for the maintenance of the scenario by the chatbot administrator is reduced.

Note that the program executed by the chatbot system of the present embodiment is provided in the ROM 22 or the like. The program executed by the chatbot system according to the present embodiment may be stored in a computer readable storage medium, such as a compact disc read only memory (CD-ROM), a flexible disk (FD), a compact disc recordable (CD-R), and a digital versatile disk (DVD), in an installable or executable file format for distribution.

Furthermore, the program executed by the chatbot system of the present embodiment may be stored on a computer connected to a network such as the internet, and may be provided by being downloaded through the network. Further, the program executed by the chatbot system according to the present embodiment can be provided or distributed through a network such as the internet.

The program executed by the chatbot system of the present embodiment has a module configuration including the above-described units (response unit 301, reception unit 302, determination unit 303). As actual hardware, the CPU 21 reads a program from the ROM 22 and executes the program, thereby loading the above respective units onto a main memory, and the response unit 301, the reception unit 302, and the determination unit 303 are implemented on the main memory.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An information processing system comprising:
circuitry configured to:
store in one or more memories, scenario information for associating a scenario with an object for leading from question information to answer information in the scenario;
receive input information from a terminal device and transmit response information responding to the input information to the terminal device based on the scenario information;
receive a change to the object included in the scenario information; and
determine whether a parent object having a corresponding relationship with a child object for which the change has been received exists.

2. The information processing system of claim 1, wherein
the circuitry is further configured to change the scenario associated with the child object in the scenario information, based on a determination that the parent object does not exist.

3. The information processing system of claim 2, wherein
the circuitry is further configured to display on a display, the scenario to be changed before changing the scenario associated with the child object in the scenario information.

4. The information processing system of claim 1, wherein
the circuitry is further configured to determine whether there is another child object that has the corresponding relationship with the parent object based on a determination that the parent object exists.

5. The information processing system of claim 4, wherein
the circuitry is further configured to change the parent object, based on a determination that there is no other child object that has the corresponding relationship with the parent object.

6. The information processing system of claim 4, wherein
the circuitry is further configured to leave the parent object unchanged, based on a determination that there is another child object that has the corresponding relationship with the parent object.

7. An information processing apparatus comprising:
circuitry configured to:
receive input information from a terminal device and transmit response information responding to the input information to the terminal device based on scenario information;
receive a change to an object included in the scenario information; and
determine whether a parent object having a corresponding relationship with a child object for which the change has been received exists.

8. The information processing apparatus of claim 7, wherein
the circuitry is further configured to change a scenario associated with the child object in the scenario information, based on a determination that the parent object does not exist.

9. The information processing apparatus of claim 8, wherein
the circuitry is further configured to display on a display, the scenario to be changed before changing the scenario associated with the child object in the scenario information.

10. The information processing apparatus of claim 7, wherein
the circuitry is further configured to determine whether there is another child object that has the corresponding relationship with the parent object based on a determination that the parent object exists.

11. The information processing apparatus of claim 10, wherein
the circuitry is further configured to change the parent object, based on a determination that there is no other child object that has the corresponding relationship with the parent object.

12. The information processing apparatus of claim 10, wherein
the circuitry is further configured to determine to leave the parent object unchanged, based on a determination that there is another child object that has the corresponding relationship with the parent object.

13. An information processing method comprising:
receiving input information from a terminal device and transmitting response information responding to the input information to the terminal device based on scenario information;
receiving a change to an object included in the scenario information; and
determining whether a parent object having a corresponding relationship with a child object for which the change has been received exists.

14. The information processing method of claim 13, further comprising changing a scenario associated with the child object in the scenario information, based on a determination that the parent object does not exist.

15. The information processing method of claim 14, further comprising displaying on a display, the scenario to be changed before changing the scenario associated with the child object in the scenario information.

16. The information processing method of claim 13, further comprising determining whether there is another child object that has the corresponding relationship with the parent object based on a determination that the parent object exists.

17. The information processing method of claim 16, further comprising changing the parent object, based on a determination that there is no other child object that has the corresponding relationship with the parent object.

18. The information processing method of claim 16, further comprising determining to leave the parent object unchanged, based on a determination that there is another child object that has the corresponding relationship with the parent object.
